(19) United States
(12) Patent Application Publication
(10) Pub. No.: US 2017/0120108 A1
(43) Pub. Date: May 4, 2017

(54) PHYSICAL FITNESS INDEX DISPLAY SYSTEM, PHYSICAL FITNESS INDEX OUTPUT DEVICE, AND PHYSICAL FITNESS INDEX DISPLAY METHOD

(71) Applicant: Seiko Epson Corporation, Tokyo (JP)

(72) Inventor: Hironori Nakazawa, Matsumoto-shi (JP)

(21) Appl. No.: 15/334,034

(22) Filed: Oct. 25, 2016

(30) Foreign Application Priority Data
Nov. 4, 2015 (JP) 2015-216385

(51) Int. Cl. A63B 24/00; G09B 5/02; A63B 71/06

(52) U.S. Cl. CPC A63B 24/0062; A63B 71/0619; G09B 5/02; A63B 2024/0065; A63B 2230/40; A63B 2230/06

(57) ABSTRACT

A physiological information analysis system includes a physiological information detection portion that obtains physiological information about a user, a body movement information detection portion that obtains activity information showing activities of the user, an index calculation portion that calculates physical fitness indices showing the physical fitness of the user based on the physiological information and the activity information, a storage portion that stores the physical fitness indices by relating the physical fitness indices to time information showing the time when the physical fitness indices are calculated, a display portion that displays information about the physical fitness indices, and a control portion that causes the display portion to display the plurality of physical fitness indices stored in the storage portion in a time-series manner based on the time information.

### CROSS-REFERENCES TO RELATED APPLICATIONS

This application claims priority to Japanese Patent Application No. 2015-216385, filed Nov. 4, 2015, the entirety of which is herein incorporated by reference.

### BACKGROUND

1. Technical Field

The invention relates to a physical fitness index display system, a physical fitness output display device, and a physical fitness index display method.

2. Related Art

Regarding a physical fitness level of a test subject, as an index of aerobic work capacity, a maximum oxygen intake, that is, a maximum level of oxygen taken into the body during exercise per unit time is known. The maximum oxygen intake is used as an index in comparing capacities of, for example, marathon runners who are required to have endurance.

As one of the methods for obtaining the maximum oxygen intake, a method is known in which breathing data (for example, oxygen concentration and carbon dioxide concentration) of a test subject is detected and the detected breathing data is analyzed (for example, see JP-A-2000-316834). Furthermore, WO 2014-207875 discloses, as a device for easily obtaining the maximum oxygen intake at low costs, a device that calculates an estimated value from measurement data obtained when a test subject exercises.

Although devices of the related art display an estimated value of a calculated maximum oxygen intake, in order to obtain a physical fitness level from the maximum oxygen intake, knowledge or know-how for analysis is necessary, and accordingly, it is difficult for a general user to easily deduce the physical fitness level from the maximum oxygen intake.

Furthermore, with the devices of the related art, it is impossible to predict how the estimated value of the maximum oxygen intake or the physical fitness level will change over time. Consequently, the devices of the related art are inconvenient because whether the current method of exercise or lifestyle is appropriate or needs to be changed cannot be determined with the devices.

### SUMMARY

An advantage of some aspects of the invention is to enable a viewer to easily ascertain a physical fitness level of a user.

The invention can be implemented as the following forms or application examples.

### APPLICATION EXAMPLE 1

A physical fitness index display system according to this application example includes a physiological information detection portion that detects physiological information about a user, an activity information detection portion that detects activity information showing activities of the user, a calculation portion that calculates physical fitness indices showing the physical fitness of the user based on the physiological information and the activity information, a storage portion that stores the physical fitness indices by relating the physical fitness indices to corresponding time information, a display portion that displays information about the physical fitness indices, and a control portion that causes the display portion to display the plurality of physical fitness indices stored in the storage portion in a time-series manner based on the time information.

According to the configuration, based on the physiological information and the activity information of the user, the physical fitness indices showing the physical fitness of the user are stored by being associated with the time information showing the time when the physical fitness indices are obtained, and the stored physical fitness indices are displayed in a time-series manner based on the time information. Therefore, the user can easily ascertain a historical trend of the physical fitness indices.

### APPLICATION EXAMPLE 2

In the physical fitness index display system according to the application example, it is preferable that the control portion classifies the physical fitness indices into a plurality of evaluation levels and causes the display portion to display information about the evaluation levels according to the physical fitness indices.

According to the configuration, the evaluation levels according to the calculated physical fitness indices can be ascertained.

### APPLICATION EXAMPLE 3

In the physical fitness index display system according to the application example, it is preferable that the control portion predicts a trend or change of the physical fitness indices and causes the display portion to display the predicted trend or change of the physical fitness indices.

According to the configuration, the predicted trend of the physical fitness indices can be ascertained.

### APPLICATION EXAMPLE 4

In the physical fitness index display system according to the application example, it is preferable that the calculation portion obtains user information about attributes of the user, estimates maximum oxygen intakes of the user based on the physiological information, the activity information, and the user information, and determines the physical fitness indices based on the user information and the maximum oxygen intake.

According to the configuration, the maximum oxygen intakes can be estimated based on the physiological information, the activity information, and the user information of the user, and the physical fitness indices can be determined based on the estimated maximum oxygen intakes.

### APPLICATION EXAMPLE 5

In the physical fitness index display system according to the application example, it is preferable that the control portion calculates a moving average of the plurality of maximum oxygen intakes estimated with the passage of time, generates physical fitness index trend information showing a trend of the calculated moving average, and causes the display portion to display the generated physical fitness index trend information.

According to the configuration, the physical fitness index trend information shows the trend of the moving average of the maximum oxygen intakes. Therefore, a variation resulting from errors or the like can be inhibited, and physical fitness index trend information with higher reliability can be provided.

### APPLICATION EXAMPLE 6

In the physical fitness index display system according to the application example, the physical fitness index trend information may be a graph in which one axis is used as a time axis and the other axis shows the evaluation levels of the physical fitness indices according to the moving average.

### APPLICATION EXAMPLE 7

In the physical fitness index display system according to the application example, it is preferable that the physical fitness index trend information displays the future moving average predicted from the current moving average by overlapping the moving average with the graph.

According to these configurations, the future moving average predicted from the current moving average can be ascertained together with the trend of the moving average so far.

### APPLICATION EXAMPLE 8

In the physical fitness index display system according to the application example, it is preferable that, in a case where the future moving average indicated in the physical fitness index trend information is changed, the control portion calculates target activity information necessary for reaching the changed moving average and causes the display portion to display the calculated target activity information.

According to the configuration, the target activity information for reaching the changed future moving average is calculated, and the calculated target activity information is displayed. Therefore, target physical fitness indices can be set, and activity information necessary for the set physical fitness indices can be ascertained.

### APPLICATION EXAMPLE 9

In the physical fitness index display system according to the application example, it is preferable that the physical fitness index trend information draws each point of the moving average by being associated with parameters used for estimating the maximum oxygen intakes.

According to the configuration, the parameters used for estimating the maximum oxygen intakes can be ascertained according to each point of the moving average.

### APPLICATION EXAMPLE 10

In the physical fitness index display system according to the application example, it is preferable that, in a case where one of the moving averages is selected, the physical fitness index trend information displays a subsidiary screen corresponding to the selected moving average.

According to the configuration, the subsidiary screen corresponding to the selected moving average can be displayed.

### APPLICATION EXAMPLE 11

A physical fitness index output device according to this application example includes a physiological information obtainment portion that obtains physiological information about a user, an activity information obtainment portion that obtains activity information showing activities of the user, a timepiece portion that outputs time information, a calculation portion that calculates physical fitness indices showing the physical fitness of the user based on the physiological information and the activity information, and an output portion that outputs the physical fitness indices by associating the physical fitness indices with the time information.

According to the configuration, based on the physiological information and the activity information of the user, the physical fitness indices showing the physical fitness of the user are obtained and stored by being associated with the time information, and the stored physical fitness indices are displayed in a time-series manner based on the time information. Therefore, the user can easily ascertain a historical trend of the physical fitness indices.

### APPLICATION EXAMPLE 12

In the physical fitness index output device according to the application example, it is preferable that the calculation portion classifies the physical fitness indices into a plurality of evaluation levels and generates information about the evaluation levels according to the physical fitness indices.

According to the configuration, the evaluation levels according to the calculated physical fitness indices can be ascertained.

### APPLICATION EXAMPLE 13

In the physical fitness index output device according to the application example, it is preferable that the calculation portion generates predictive information predicting a trend or change of the physical fitness indices, and the output portion preferably outputs the predictive information.

According to the configuration, the predictive trend of the physical fitness indices can be ascertained.

### APPLICATION EXAMPLE 14

In the physical fitness index output device according to the application example, the output portion may be a communication portion and may communicate the physical fitness indices and the time information to an external instrument.

### APPLICATION EXAMPLE 15

In the physical fitness index output device according to the application example, the communication portion may obtain information about the evaluation levels corresponding to the physical fitness indices communicated to the external instrument.

### APPLICATION EXAMPLE 16

In the physical fitness index output device according to the application example, the communication portion may obtain predictive information which is generated based on the communicated physical fitness indices and obtained by predicting a trend or change of the physical fitness indices.

### APPLICATION EXAMPLE 17

In the physical fitness index output device according to the application example, the output portion may bean informing portion and may inform the user of the physical fitness indices and the time information.

### APPLICATION EXAMPLE 18

In the physical fitness index output device according to the application example, the informing portion may be a display portion, and the display portion may display a graph in which one axis is used as a time axis and the other axis shows at least one of the physical fitness indices or the evaluation levels of the physical fitness indices.

### APPLICATION EXAMPLE 19

In the physical fitness index output device according to the application example, the informing portion may display the graph showing the evaluation levels of the physical fitness indices and the predictive information.

### APPLICATION EXAMPLE 20

The physical fitness index output device according to the application example may include an operation portion that accepts an operation of changing a relative position between a display position of the graph and a display position of the predictive information, and in a case where the control portion determines that the relative position has been changed based on a signal from the operation portion, the informing portion may display necessary activity information necessary for reaching physical fitness indices corresponding to the predictive information of which the relative position has been changed.

### APPLICATION EXAMPLE 21

In the physical fitness index output device according to the application example, the operation portion, which accepts an operation of selecting the physical fitness indices displayed as the graph on the informing portion, and the control portion may cause the informing portion to display a subsidiary screen for displaying information about the selected physical fitness indices based on a signal from the operation portion.

### APPLICATION EXAMPLE 22

In the physical fitness index output device according to the application example, the informing portion may display the evaluation levels of the physical fitness indices and the predictive information in different aspects.

### APPLICATION EXAMPLE 23

A physical fitness index output device according to this application example includes a calculation portion that calculates physical fitness indices showing the physical fitness of a user based on information from a sensor mounted on the body of the user, and an output portion that outputs the physical fitness indices and time information showing the time when the information from the sensor is obtained, by relating the physical fitness indices to the time information.

### APPLICATION EXAMPLE 24

In the physical fitness index output device according to the application example, the calculation portion may classify the physical fitness indices into a plurality of evaluation levels and generate evaluation level information about the evaluation levels according to the physical fitness indices, and the output portion may output the evaluation level information.

### APPLICATION EXAMPLE 25

In the physical fitness index output device according to the application example, the sensor may include a physiological information detection portion that detects physiological information about the user and a body movement information detection portion that detects body movement information about the user.

### APPLICATION EXAMPLE 26

In the physical fitness index output device according to the application example, the physical fitness indices may include at least any of a cardiopulmonary function, a maximum oxygen intake, a threshold of anaerobic work, physical fitness age, and a maximum heart rate.

### APPLICATION EXAMPLE 27

In the physical fitness index output device according to the application example, the output portion may bean informing portion and may inform the user of the physical fitness indices and the time information.

### APPLICATION EXAMPLE 28

In the physical fitness index output device according to the application example, the informing portion may be a display portion, and the display portion may display a graph showing a time-series change of the physical fitness indices or the evaluation levels of the physical fitness indices based on the physical fitness indices and the time information.

### APPLICATION EXAMPLE 29

In the physical fitness index output device according to the application example, the display portion may display either predictive physical fitness indices that are predicted based on the physical fitness indices and the time information or predictive evaluation levels that are deduced based on the predictive physical fitness indices.

### APPLICATION EXAMPLE 30

A physical fitness index display method according to this application example includes obtaining physiological information of a user, activity information showing activities of the user, and time information showing the time when the physiological information and the activity information are obtained, calculating physical fitness indices showing the physical fitness of the user based on the physiological information and the activity information, and displaying the physical fitness indices in a time-series manner based on the time information.

According to the method, based on the physiological information and the activity information of the user, the physical fitness indices showing the physical fitness of the user are obtained and stored by being associated with the time information, and the stored physical fitness indices are displayed in a time-series manner based on the time information. Therefore, the user can easily ascertain a historical trend of the physical fitness indices.

### BRIEF DESCRIPTION OF THE DRAWINGS

The invention will be described with reference to the accompanying drawings, wherein like numbers reference like elements.

FIG. 1 is a schematic view illustrating a physiological information analysis system according to the present embodiment.

FIG. 2 is a block diagram illustrating the constitution of a physiological information detection device.

FIG. 3 is a block diagram illustrating the constitution of a control portion.

FIG. 4 is a block diagram illustrating the constitution of an information processing device.

FIG. 5 is a block diagram illustrating the constitution of a control portion.

FIG. 6 is a view illustrating an example of a user information registration screen.

FIG. 7 is a block diagram illustrating the constitution of a server device.

FIG. 8 is a block diagram illustrating the constitution of a control portion.

FIG. 9 is a view illustrating an example of zone setting information.

FIG. 10 is a view illustrating an example of a calculation information table.

FIG. 11 is a view illustrating an example of a physical fitness index trend screen.

FIG. 12 is a view illustrating an example of the physical fitness index trend screen.

FIG. 13 is a view illustrating an example of the physical fitness index trend screen.

FIG. 14 is a view illustrating an example of the physical fitness index trend screen.

FIG. 15 is a view illustrating an example of the physical fitness index trend screen.

### DESCRIPTION OF EXEMPLARY EMBODIMENTS

Hereinafter, an embodiment of the invention will be described with reference to drawings.

### Embodiment

Hereinafter, a physical fitness index display system according to an embodiment will be described with reference drawings.

### Schematic Constitution of Physiological Information Analysis System

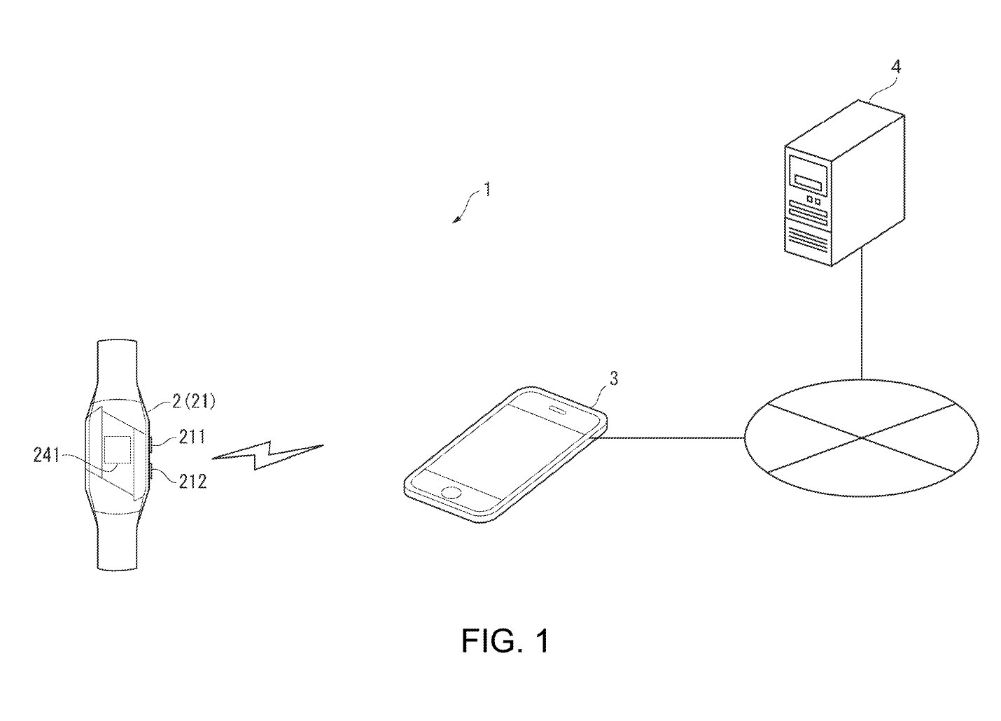

FIG. 1 is a schematic view illustrating a physiological information analysis system 1 as a physical fitness index display system.

As shown in FIG. 1, the physiological information analysis system. 1 according to the present embodiment includes a physiological information detection device 2, an information processing device 3, and a server device 4.

In the physiological information analysis system 1, the physiological information detection device 2 detects physiological information and body movement information and transmits the information to the information processing device 3. Based on the received physiological information and body movement information and user information input by a user, the information processing device 3 calculates and presents estimated values of maximum oxygen intakes and exercise ability indices. The information processing device 3 is connected to the server device 4 through a network. When receiving the presentation information (for example, message information based on maximum oxygen intakes of the user that will be described later) from the information processing device 3, the physiological information detection device 2 informs the user of the presentation information.

The server device 4 is communicably connected to the information processing device 3, and has a function of obtaining estimated values of maximum oxygen intakes based on the information transmitted from the information processing device 3 or a function of predicting physical fitness of the user based on the estimated values of the maximum oxygen intakes.

Hereinafter, each constitution of the physiological information analysis system 1 will be described. The physiological information analysis system 1 corresponds to a physical fitness index display system.

### Constitution of Detection Device

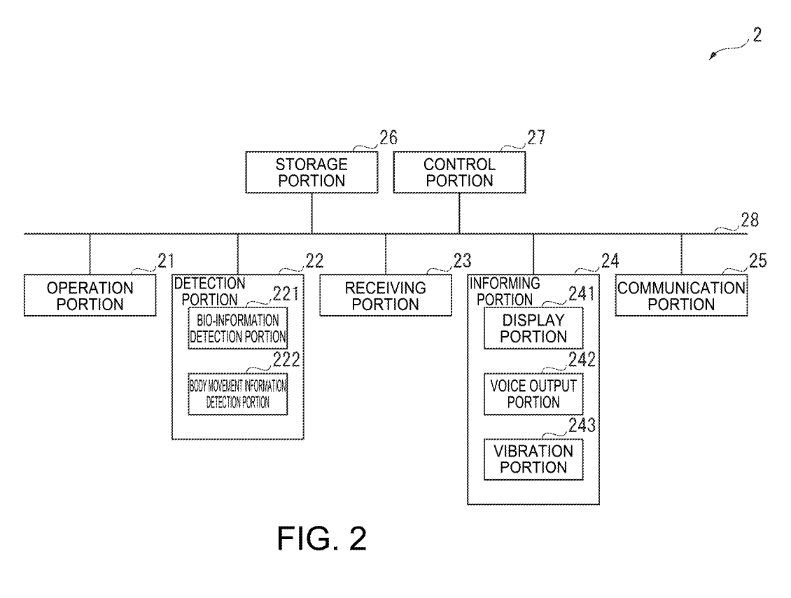

FIG. 2 is a block diagram showing the constitution of the physiological information detection device 2.

The physiological information detection device 2 corresponds to a detection device according to the invention, and is a wearable instrument which is mounted on the body (arm, wrist, and the like) of the user and detects and stores physiological information and body movement information. The physiological information detection device 2 transmits each of the detected and stored physiological information and body movement information to the information processing device 3 and informs the user of the presentation information received from the information processing device 3.

As shown in FIG. 2, the physiological information detection device 2 has an operation portion 21, a detection portion 22, a receiving portion 23, an informing portion 24, a communication portion 25, a storage portion 26, and a control portion 27. These portions 21 to 27 are electrically connected to each other through a bus line 28.

### Constitution of Operation Portion

The operation portion 21 is a portion which accepts an input operation performed by the user and outputs an operation signal according to the input operation to the control portion 27. The operation portion 21 outputs an operation signal according to the input operation of buttons 211 and 212 (see FIG. 1), which are provided to be exposed from the outer surface of a body of the physiological information detection device 2, to the control portion 27. The operation portion 21 may be constituted such that it recognizes voice of the user (sound of the user) and outputs an operation signal according to the voice to the control portion 27. The operation portion 21 may also be constituted such that it detects a tapping operation of the user and outputs an operation signal according to the tapping operation to the control portion 27.

### Constitution of Detection Portion

The detection portion 22 has a physiological information detection portion 221 and a body movement information detection portion 222 that detect the physiological information and the body movement information of the user respectively. The physiological information detection portion 221 corresponds to a physiological information obtainment portion, and the body movement information detection portion 222 corresponds to an activity information obtainment portion.

The physiological information detection portion 221 detects physiological information of the user wearing the physiological information detection device 2. In the present embodiment, the physiological information detection portion 221 has a pulse wave sensor that detects a pulse wave as physiological information and outputs a pulse wave signal showing the pulse wave. The physiological information detection portion 221 may be constituted as an electrocardiogram sensor that detects a heart rate as physiological information instead of a pulse wave. Alternatively, the physiological information detection portion 221 may be constituted such that it detects blood pressure, body temperature, a blood glucose level, and the like in addition to the pulse wave and the heart rate.

The body movement information detection portion 222 detects, as body movement information (activity information) of the user, information about the activities of the user, that is, acceleration that changes according to the body movement of the user. In the present embodiment, the body movement information detection portion 222 has an acceleration sensor that detects an acceleration value (acceleration data) acting as body movement information according to the body movement of the user.

### Constitution of Receiving Portion

The receiving portion 23 obtains positional information showing the current position of the physiological information detection device 2 (that is, positional information showing the current position of the user). For example, the receiving portion 23 corresponds to a satellite-based positioning system such as a Global Positioning System (GPS), and obtains positional information showing the current position based on radio waves transmitted from a satellite. The receiving portion 23 outputs the obtained positional information to the control portion 27. The positional information is used for calculating a running distance, a running speed, and the like of the user by using an analysis portion 366 which will be described later.

### Constitution of Informing Portion

The informing portion 24 informs the user of various information under the control of the control portion 27. For example, the informing portion 24 informs the user of the operation conditions of the physiological information detection device 2, detected information, and the message information received from the information processing device 3. The informing portion 24 has at least one of a display portion 241, a voice output portion 242, and a vibration portion 243.

The display portion 241 has liquid crystals that function to display information, and displays various information.

The voice output portion 242 is constituted with a speaker and outputs voice according to the voice information input from the control portion 27. For example, when the display portion 241 displays a message display screen, the voice output portion 242 outputs signal sound notifying the display of message.

The vibration portion 243 has a motor that is driven under the control of the control portion 27 which will be described later, and informs the user of the conditions of the physiological information detection device 2 through vibration resulting from the driving of the motor.

### Constitution of Communication Portion

The communication portion 25 corresponds to a transmission portion of the detection device according to the invention and has a communication module that can communicate with the information processing device 3 and the like. The communication portion 25 transmits each of the detected and obtained physiological information, body movement information, and positional information to the information processing device 3. In the present embodiment, the communication portion 25 wirelessly communicates with the information processing device 3 by a near field wireless communication method. However, the communication portion 25 may communicate with the information processing device 3 through a relay device such as a cradle or through a cable. Furthermore, the communication portion 25 may communicate with an external instrument such as the information processing device 3 or the server device 4 through wireless communication or a network.

### Constitution of Storage Portion

The storage portion 26 is constituted with a storage device having a flash memory or the like and stores programs or data necessary for the operation of the physiological information detection device 2.

For example, the storage portion 26 stores in advance, as data, connection information for communicating with and being connected to the information processing device 3 through the communication portion 25.

Under the control of the control portion 27, the storage portion 26 also stores the physiological information and the body movement information detected by the detection portion 22 and the positional information obtained by the receiving portion 23. Furthermore, the storage portion 26 stores the presentation information (message information) obtained from the information processing device 3 through the communication portion 25.

### Constitution of Control Portion

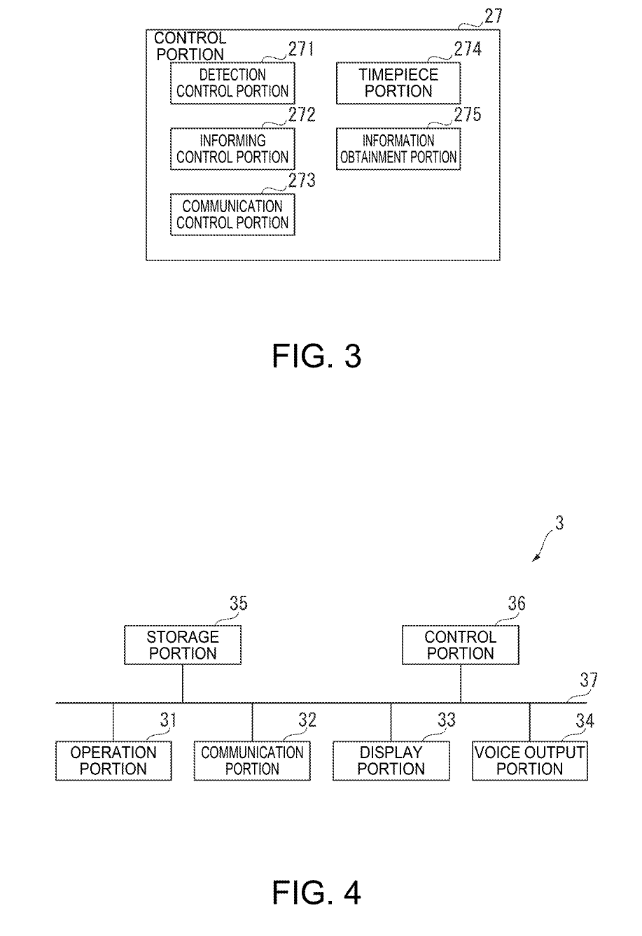

FIG. 3 is a block diagram illustrating the constitution of the control portion 27.

The control portion 27 is constituted with a processing circuit such as a Central Processing Unit (CPU), and controls the operation of the physiological information detection device 2 autonomously or according to the operation signal input from the operation portion 21 in response to the operation performed by the user. For example, the control portion 27 obtains the physiological information and body movement information detected by the detection portion 22 or the positional information obtained by the receiving portion 23, and transmits the information to the information processing device 3.

The control portion 27 has, as functional portions realized by the execution of programs stored in the storage portion 26 by the processing circuit, a detection control portion 271, an informing control portion 272, a communication control portion 273, a timepiece portion 274, and an information obtainment portion 275 as shown in FIG. 3.

The detection control portion 271 controls the operation of the detection portion 22 and causes the storage portion 26 to store the detection results obtained by the detection portion 22. In a case where the detection portion 22 is in a state of being able to detect physiological information and body movement information, the detection control portion 271 causes the detection portion 22 to detect the respective information. In a case where the detection portion 22 is not in a state of being able to detect the respective information, the detection control portion 271 stops the operation of the detection portion 22 such that power consumption is suppressed.

The informing control portion 272 controls the operation of the informing portion 24. For example, the informing control portion 272 controls the operation of the display portion 241 of the informing portion 24 so as to cause the display portion 241 to display the physiological information and body movement information detected by the detection portion 22.

When the message information is received from the information processing device 3, the informing control portion 272 causes the informing portion 24 to inform the user of the message information. For example, the informing control portion 272 causes the display portion 241 to display a message display screen including the message according to the message information. Furthermore, for example, the informing control portion 272 causes the voice output portion 242 to output signal sound notifying the display of the message and vibrates the vibration portion 243. In this way, the user can recognize that he or she is highly likely to develop heart diseases.

The communication control portion 273 controls the communication portion 25 so as to cause the communication portion 25 to communicate with the information processing device 3 based on the connection information stored in the storage portion 26.

The timepiece portion 274 clocks the current date and time.

The information obtainment portion 275 obtains the physiological information and body movement information detected by the detection portion 22 and the positional information obtained by the receiving portion 23, and stores the information in the storage portion 26. At this time, the information obtainment portion 275 causes the physiological information, the body movement information, the positional information, and the date and time when the above information is detected or obtained to be stored with reference to the current date and time clocked by the timepiece portion 274.

The physiological information, the body movement information, and the positional information obtained and stored in this way are transmitted to the information processing device 3 through the communication portion 25 under the control of the communication control portion 273.

### Constitution of Information Processing Device

FIG. 4 is a block diagram illustrating the constitution of the information processing device 3.

The information processing device 3 corresponds to a physiological information analysis device according to the invention and is constituted with, for example, a smart phone (multifunctional mobile phone), a tablet PC, a Personal Computer (PC), or the like. The information processing device 3 calculates (determines) exercise intensity of the user based on the physiological information and body movement information received from the physiological information detection device 2 and a level of exercise habit (level of activity amount) of the user based on the exercise intensity and the exercise time. Then, based on the user information and the level of exercise habit input into a registration screen displayed, the information processing device 3 estimates a maximum oxygen intake. Furthermore, the information processing device 3 transmits the message information including a message according to the estimated maximum oxygen intake and displays the message information. In addition, the information processing device 3 displays an index of an exercise capacity based on the maximum oxygen intake according to the operation performed by the user.

As shown in FIG. 4, the information processing device 3 includes an operation portion 31, a communication portion 32, a display portion 33, a voice output portion 34, a storage portion 35, and a control portion 36, and these are connected to each other through a bus line 37.

### Constitution of Operation Portion

The operation portion 31 is a portion which accepts an input operation performed by the user and outputs the operation information according to the input operation to the control portion 36. The operation portion 31 can be constituted with, for example, a physical key or a touch panel provided in the body of the information processing device 3 or with a keyboard and a pointing device connected to the information processing device 3 through wire or wirelessly.

### Constitution of Communication Portion

The communication portion 32 has a first communication module that can communicate with the physiological information detection device 2, and a second communication module that can communicate with the server device 4 connected through a network. The communication portion 32 communicates with external devices such as the physiological information detection device 2 and the server device 4 under the control of the control portion 36. In a case where each of the physiological information detection device 2 and the server device 4 can communicate with the communication portion 32 by the same communication method, the communication portion 32 may include one of the first communication module and the second communication module.

### Constitution of Display Portion and Voice Output Portion

The display portion 33 corresponds to a range presentation portion, an index presentation portion, and a trend information presentation portion according to the invention. The display portion 33 can be constituted with, for example, various display panels such as a liquid crystal display panel, an Organic Electroluminescence (EL) display panel, and an electrophoretic display panel, and displays a screen generated by a presentation information generation portion 370 which will be described later. Specifically, the display portion 33 displays an Operating System (OS) executed by the control portion 36 and execution screens of various applications (for example, execution screens ES which will be described later).

The voice output portion 34 is constituted with a speaker, and outputs voice according to the voice information input from the control portion 36. For example, in a case where the control portion 36 executes an information management application which will be described later, the voice output portion 34 outputs voice according to the information presented to the user.

### Constitution of Storage Portion

The storage portion 35 is constituted with a storage devices such as a Solid State Drive (SSD), a Hard Disk Drive (HDD), and a flash memory, and stores programs and data necessary for the operation of the information processing device 3. The storage portion 35 stores, as such programs, the Operating System (OS) controlling the information processing device 3 and various application programs.

Furthermore, the storage portion 35 stores various information transmitted from the physiological information detection device 2, the content input into the registration screen, which will be described later, and the like.

### Constitution of Control Portion

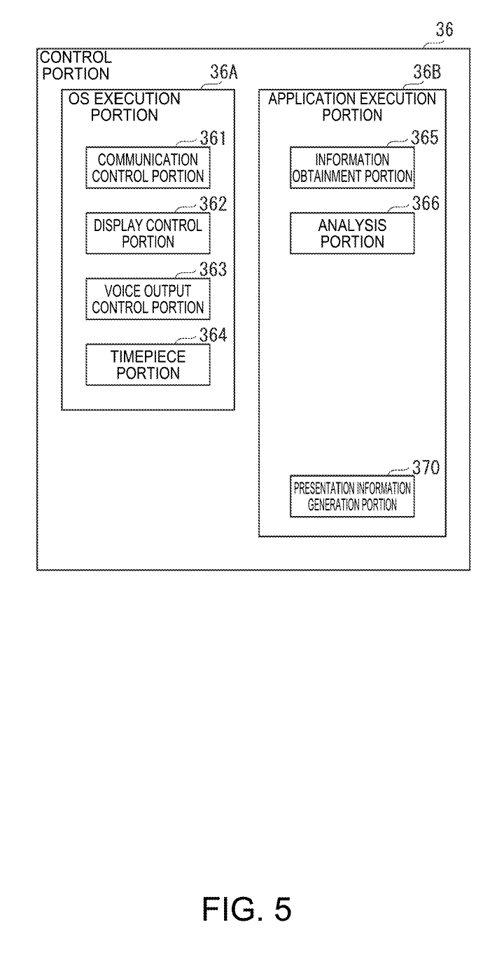

FIG. 5 is a block diagram illustrating the constitution of the control portion 36.

The control portion 36 is constituted with a Central Processing Unit (CPU). By executing the programs stored in the storage portion 35, the control portion 36 controls the operation of the information processing device 3. The control portion 36 has an OS execution portion 36A and an application execution portion 36B.

The OS execution portion 36A is a functional portion that executes OS stored in the storage portion 35, and has a communication control portion 361, a display control portion 362, a voice output control portion 363, and a timepiece portion 364.

The communication control portion 361 controls the communication portion 32 so as to communicate with external instruments or the server device 4.

The display control portion 362 causes the display portion 33 to display the execution screen and execution screens of other applications and OS (execution screens generated by other mechanisms).

The voice output control portion 363 outputs voice information of voice, which is output at the time when OS or applications are executed, to the voice output portion 34.

The timepiece portion 364 clocks the current date and time.

The application execution portion 36B executes an application designated by the OS execution portion 36A according to the operation information input from the operation portion 31, among the applications stored in the storage portion 35.

The application execution portion 36B has an information obtainment portion 365, an analysis portion 366, and a presentation information generation portion 370 each functioning as a result of the execution of the application programs stored in the storage portion 35.

The information obtainment portion 365 obtains information input by the user operating the operation portion 31, through an execution screen of an application program (user information registration screen) which will be described later. In addition, the information obtainment portion 365 obtains various information (physiological information, body movement information, positional information, and date and time information) from the physiological information detection device 2 through the communication portion 32, and stores the information in the storage portion 35. The information about the user obtained by the information obtainment portion 365 is transmitted to the server device 4 through communication such that a maximum oxygen intake is estimated or analyzed.

A constitution may be adopted in which the information processing device 3 includes a positional information obtainment portion, and the positional information from the information processing device 3 is used instead of the positional information from the physiological information detection device 2. In this case, the physiological information detection device 2 can be miniaturized without impairing the function of the system, and accordingly, user-friendliness is improved.

### User Information Registration Screen

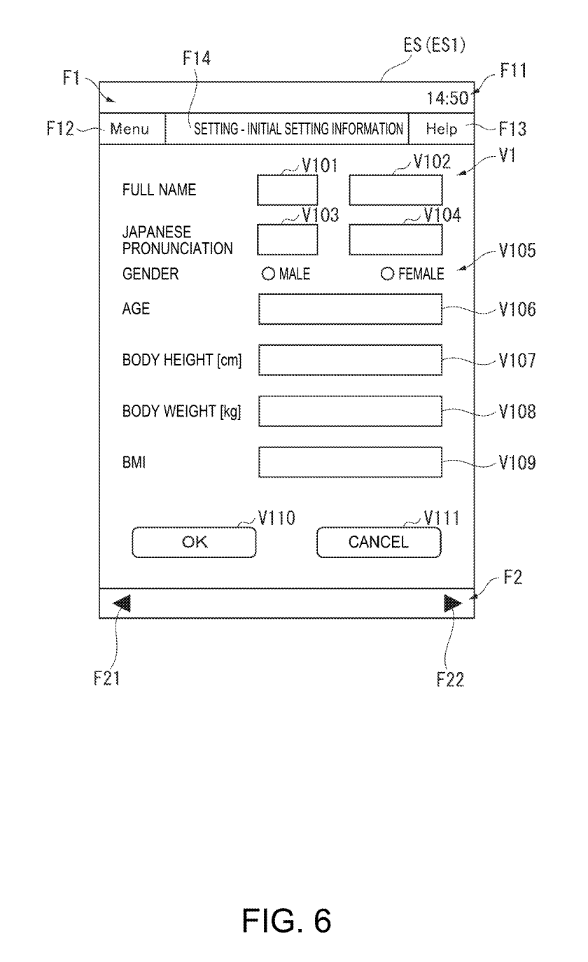

FIG. 6 is a view illustrating an example of a user information registration screen ES1.

The user information registration screen ES1 is one of the execution screens ES displayed at the time of executing application programs, and is a screen for inputting and registering user information. As shown in FIG. 6, within the user information registration screen ES1, fixed display regions F1 and F2 are set in the upper portion and the lower portion of the screen respectively, and a variable display region V1 is set therebetween.

At the upper end of the fixed display region F1 in the upper portion of the screen, a time display region F11 in which the current time clocked by the timepiece portion 364 is set is disposed. On the left side at the lower end of the fixed display region F1, a button F12 that shifts the screen to a menu screen (not shown in the drawing) when being pressed (input) is disposed, and on the right side at the lower end of the fixed display region F1, a button F13 that shifts the screen to a help screen (not shown in the drawing) when being pressed is disposed. In a region interposed between the buttons F12 and F13, a title F14 showing the content of the screen is disposed.

On the left and right sides of the fixed display region F2 in the lower portion of the screen, buttons F21 and F22 are disposed. The buttons F21 and F22 are buttons for shifting screens.

The variable display region V1 is provided with input fields for each of the user information (the user's full name) and initial setting information.

Specifically, the variable display region V1 is provided with last name input fields V101 and V103, into which the user's last name is input in Kanji and Hiragana among the user information, and first name input fields V102 and V104 into which the user's first name is input in Kanji and Hiragana.

In the variable display region V1, input fields V105 to V109, into which the gender, age, body height, body weight, and BMI of the user are respectively input among the initial setting information, registration button V110, and a cancel button V111 are disposed. Among these, the gender input field V105 into which the gender of the user is input is provided with a radio button for selecting “male” or “female”.

When the registration button V110 is pressed, the contents input into each of the input fields V101 to V109 are obtained by the information obtainment portion 365 and stored into the storage portion 35.

BMI can be calculated based on the body height and the body weight. Therefore, when the body height and the body weight are input into the body height input field V107 and the body weight input field V108, based on the input body height and body weight, BMI is set in the BMI input field V109.

In contrast, when the cancel button V111 is pressed, the screen returns to a screen (for example, a menu screen) displayed immediately before the user information registration screen ES1.

The user information input into the user information registration screen ES1 is obtained by the information obtainment portion 365.

As shown in FIG. 5, the analysis portion 366 analyzes the physiological information, body movement information, positional information, and date and time information received from the physiological information detection device 2, and generates analytical information (activity amount information) such as calories consumed by the user, a running distance and a walking distance, a step count, and an exercise time (activity amount). The activity amount information generated by the analysis portion 366 is transmitted to the server device 4 through communication.

In the present embodiment, although the analytical processing performed by the analysis portion 366 is executed on a weekly basis after the user begins to use the physiological information detection device 2, the term can be appropriately changed.

The presentation information generation portion 370 generates the execution screen ES of an application program. For example, the presentation information generation portion 370 generates the user information registration screen ES1 (see FIG. 6). The presentation information generation portion 370 also generates an analysis screen FS relating to physical fitness indices based on the information of physical fitness indices relating to physical fitness that is transmitted from the server device 4. In the present embodiment, an aspect is considered in which the physical fitness indices includes at least one of a cardiopulmonary function, a maximum oxygen intake, a threshold of anaerobic work, physical fitness age, and a maximum heart rate.

The display control portion 362 causes the display portion 33 to display the execution screen ES generated by the presentation information generation portion 370. Furthermore, based on the information about the physical fitness indices transmitted from the server device 4, the display control portion 362 controls the display portion 33 such that the display portion 33 displays the analysis screen FS showing a temporal trend of the physical fitness indices. The analysis screen FS relating to the physical fitness indices will be described later.

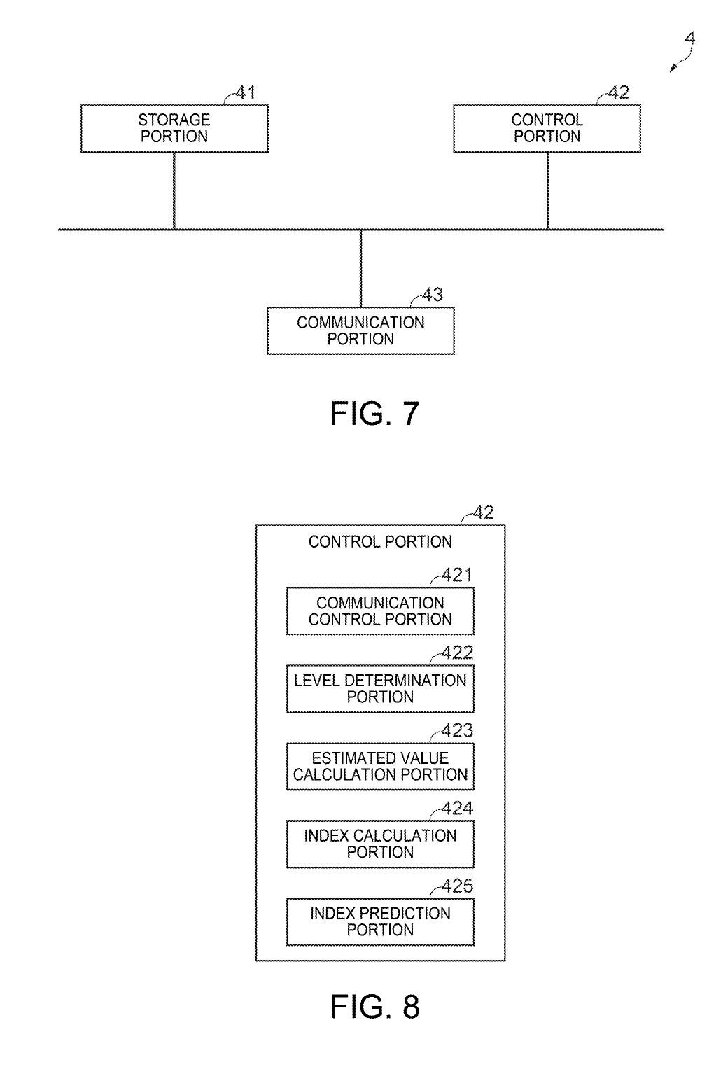

FIG. 7 is a block diagram illustrating the constitution of the server device 4.

The server device 4 includes a storage portion 41 that stores information, a control portion 42 that controls various functions, and a communication portion 43 that performs communication through a network.

FIG. 8 is a block diagram illustrating the constitution of the control portion 42 of the server device 4.

The control portion 42 is constituted with a processing circuit such as a Central Processing Unit (CPU), and has various functions including a function (method) of causing the display portion 33 of the information processing device 3 to display information about physical fitness indices in cooperation with software. The control portion 42 includes a communication control portion 421, a level determination portion 422, an estimated value calculation portion 423, an index calculation portion 424, and an index prediction portion 425.

The communication control portion 421 controls the communication portion 43 so as to communicate with an external instrument such as the physiological information detection device 2 or the information processing device 3.

The level determination portion 422 determines a level of exercise habit of the user based on the activity amount information obtained for a predetermined period of time (for example, for one week). The level of exercise habit will be specifically described below.

### Zone Setting Information

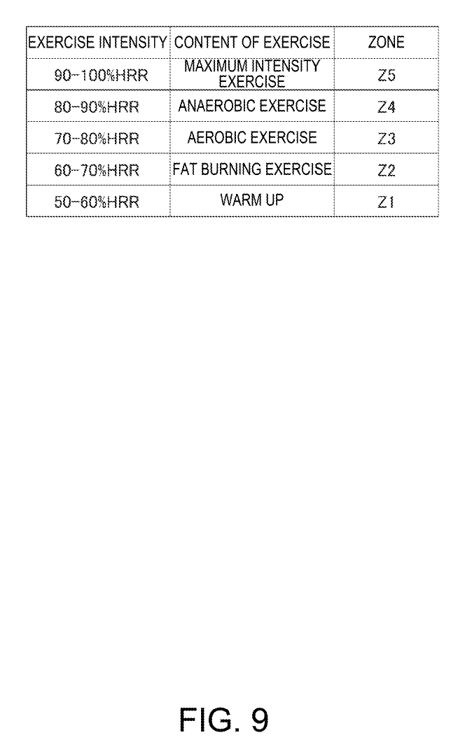

FIG. 9 is a view illustrating an example of zone setting information stored in the storage portion 41. The zone setting information is a table in which exercise intensities of the exercises performed by the user are classified into a plurality of sections called zones.

Specifically, as shown in FIG. 9, the zone setting information is divided into a zone (Z1) in which % Heart Rate Reserved (% HRR) showing the exercise intensity is equal to or greater than 50 and less than 60, a zone (Z2) in which % HRR is equal to or greater than 60 and less than 70, a zone (Z3) in which % HRR is equal to or greater than 70 and less than 80, a zone (Z4) in which % HRR is equal to or greater than 80 and less than 90, and a zone (Z5) in which % HRR is equal to or greater than 90 and equal to or less than 100, and the content of the exercise and the zone name are set for each zone.

Specifically, in the zone in which % HRR is equal to or greater than 50 and less than 60, “warm up” is set as the content of the exercise, and “Z1” is set as the zone name. In the zone in which % HRR is equal to or greater than 60 and less than 70, “fat burning exercise” is set as the content of the exercise, and “Z2” is set as the zone name. In the zone in which % HRR is equal to or greater than 70 and less than 80, “aerobic exercise” is set as the content of exercise, and “Z3” is set as the zone name. In the zone in which % HRR is equal to or greater than 80 and less than 90, “anaerobic exercise” is set as the content of the exercise, and “Z4” is set as the zone name. In the zone in which % HRR is equal to or greater than 90 and equal to or less than 100, “maximum intensity exercise” is set, and “Z5” is set as the zone name.

In the present embodiment, the zones are set based on % HRR which is exercise intensity based on a Karvonen method, but the invention is not limited thereto. For example, the zones may be set based on % Maximum Heart Rate (% MHR). Furthermore, the zones may be set as a fat burning zone and a carbohydrate burning zone or as an aerobic exercise zone, an anaerobic exercise zone, and a maximum intensity exercise zone.

### Calculation Information

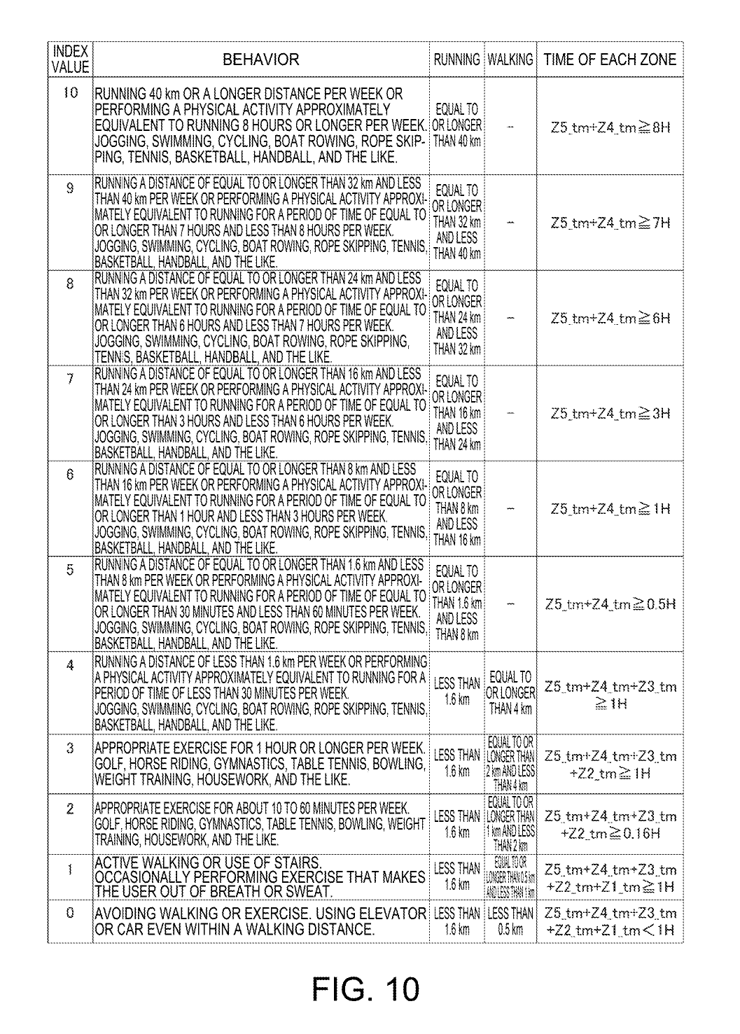

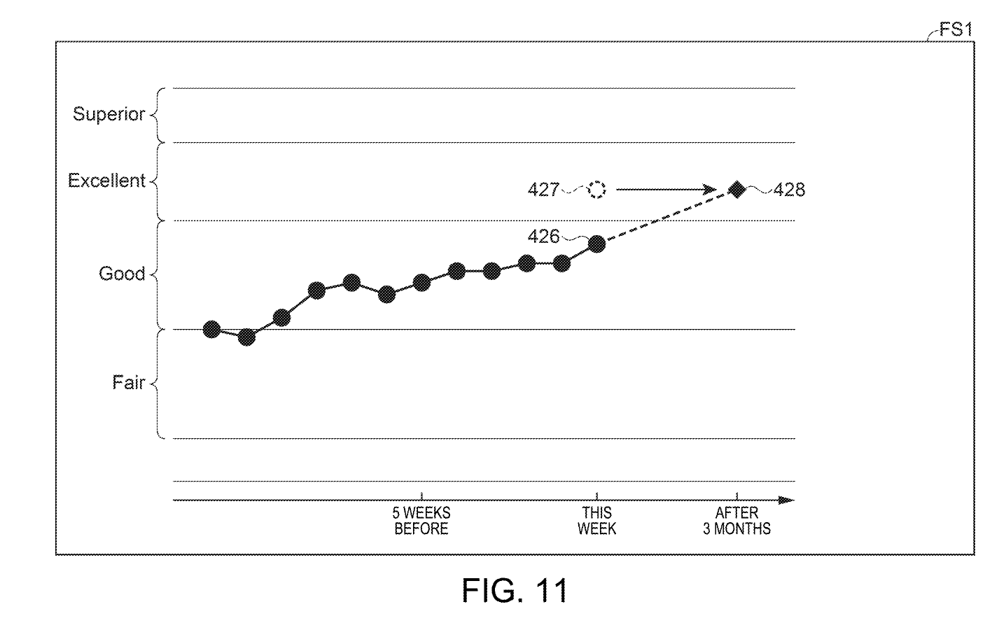

FIG. 10 is a view illustrating an example of a calculation information table stored in the storage portion 41. The calculation information is information for calculating a level of exercise habit that becomes an index value at the time of estimating a maximum oxygen intake of the user.

The level of exercise habit will be described. The level of exercise habit is a level obtained by expressing exercise habits, which are calculated from the frequency of the exercise performed by the user, the intensity of the exercise performed, and the like based on the physiological information and body movement information obtained for a predetermined period of time (for example, for one week), by using stepwise set numerical values. In the present embodiment, the level of exercise habit is set to be eleven levels on a scale of “0” to “10” numerically showing the levels.

The classification into levels based on the content of the exercise (behavior), the running distance, and the waking distance according to each level of exercise habit described below is preset based on a Physical Activity Level (PAL) and a Physical Activity Rating (PAR).

As the calculation information for calculating the level of exercise habit, for example, as shown in FIG. 10, the content of the activity corresponding to the level of exercise habit, the corresponding conditions relating to the running distance and the waking distance, and the corresponding conditions relating to the total exercise time of the zone per week are set for each level of exercise habit expressed on a scale of “0 to 10”.

Specifically, as a behavior of the user corresponding to the level “10” of exercise habit, “running 40 km or a longer distance per week or a physical activity approximately equivalent to running for 8 hours or longer per week” is set. As specific examples of the physical activity, “jogging, swimming, cycling, boat rowing, rope skipping, tennis, basketball, handball, and the like” are listed.

As a running distance of the level of exercise habit, “equal to or longer than 40 km” is set. Furthermore, as the corresponding conditions relating to the total time, “the total exercise time of the zone Z5 and the zone Z4 should be 8 hours or longer” is set.

As a behavior of the user corresponding to the level “9” of exercise habit, “running a distance of equal to or longer than 32 km and less than 40 km per week or a physical activity approximately equivalent to running for a period of time of equal to or longer than 7 hours and less than 8 hours per week” is set. As a running distance of the level of exercise habit, “equal to or longer than 32 km and less than 40 km” is set. Furthermore, as the corresponding conditions relating to the total time, “the total exercise time of the zone Z5 and the zone Z4 should be equal to or longer than 7 hours” is set.

As a behavior of the user corresponding to the level “8” of exercise habit, “running a distance of equal to or longer than 24 km and less than 32 km per week, or a physical activity approximately equivalent to running for a period of time of equal to or longer than 6 hours and less than 7 hours per week” is set. As the running distance of the level of exercise habit, “equal to or longer than 24 km and less than 32 km” is set. As the corresponding conditions relating to the total time, “the total exercise time of the zone Z5 and the zone Z4 should be equal to or longer than 6 hours” is set.

As a behavior of the user corresponding to the level “7” of exercise habit, “running a distance of equal to or longer than 16 km and less than 24 km per week, or a physical activity approximately equivalent to running for a period of time of equal to or longer than 3 hours and less than 6 hours per week” is set. As the running distance of the level of exercise habit, “equal to or longer than 16 km and less than 24 km” is set. As the corresponding conditions relating to the total time, “the total exercise time of the zone Z5 and the zone Z4 should be equal to or longer than 3 hours” is set.

As a behavior of the user corresponding to the level “6” of exercise habit, “running a distance of equal to or longer than 8 km and less than 16 km per week, or a physical activity approximately equivalent to running for a period of time of equal to or longer than 1 hour and less than 3 hours per week” is set. As the running distance of the level of exercise habit, “equal to or longer than 8 km and less than 16 km” is set. As the corresponding conditions relating to the total time, “the total exercise time of the zone Z5 and the zone Z4 should be equal to or longer than 1 hour” is set.

As a behavior of the user corresponding to the level “5” of exercise habit, “running a distance of equal to or longer than 1.6 km and less than 8 km per week, or a physical activity approximately equivalent to running for a period of time of equal to or longer than 30 minutes and less than 60 minutes per week” is set. As the running distance of the level of exercise habit, “equal to or longer than 1.6 km and less than 8 km” is set. As the corresponding conditions relating to the total time, “the total exercise time of the zone Z5 and the zone Z4 should be equal to or longer than 0.5 hours” is set.

As a behavior of the user corresponding to the level “4” of exercise habit, “running a distance of less than 1.6 km per week, or a physical activity approximately equivalent to running for a period of time of less than 30 minutes per week” is set. As the running distance of the user, “less than 1.6 km” is set, and as the walking distance, “equal to or longer than 4 km” is set. As the corresponding conditions relating to the total time, “the total exercise time of the zone Z5, the zone Z4, and the zone Z3 should be equal to or longer than 1 hour” is set.

As a behavior of the user corresponding to the level “3” of exercise habit, “an appropriate exercise for 1 hour or longer per week” is set. Examples of the appropriate exercise include golf, horse riding, gymnastics, table tennis, bowling, weight training, housework, and the like.

As the running distance of the level of exercise habit, “less than 1.6 km” is set, and as the walking distance, “equal to or longer than 2 km and less than 4 km” is set. As the corresponding conditions relating to the total time, “the total exercise time of the zone Z5, the zone Z4, the zone Z3, and the zone Z2 should be equal to or longer 1 hours” is set.

As a behavior of the user corresponding to the level “2” of exercise habit, “an appropriate exercise for a period of time of equal to or longer than 10 minutes and less than 60 minutes per week” is set. As the running distance of the level of exercise habit, “less than 1.6 km” is set, and as the walking distance, “equal to or longer than 1 km and less than 2 km” is set. As the corresponding conditions relating to the total time, “the total exercise time of the zone Z5, the zone Z4, the zone Z3, and the zone Z2 should be equal to or longer than 0.16 hours” is set.

As a behavior of the user corresponding to the level “1” of exercise habit, “a behavior of actively using stairs, occasionally performing a behavior that makes the user out of breath or sweat” is set. As the running distance of the level of exercise habit, “less than 1.6 km” is set, and as the walking distance, “equal to or longer than 0.5 km and less than 1 km” is set. As the corresponding conditions relating to the total time, “the total exercise time in all of the zone Z1 to the zone Z5 should be equal to or longer than 1 hour” is set.

As a behavior of the user corresponding to the level “0” of exercise habit, “a behavior of avoiding walking or exercise, a behavior of using an elevator, or a behavior of taking a car even within a walking distance” is set. As the running distance of the level of exercise habit, “less than 1.6 km” is set, and as the walking distance, “less than 0.5 km” is set. As the corresponding conditions relating to the total time, “the total exercise time of all of the zone Z1 to the zone Z5 should be less than 1 hour” is set.

A level of exercise habit of the user is determined based on any of the behavior of the user per week, the running distance and the walking distance, and the total exercise time of zones among the aforementioned calculation information.

The behavior, the running distance, the walking distance, and the total exercise time of the respective zones assigned to each level of exercise habit are merely an example, and may be appropriately changed according to the user information, the condition of the user, and an estimation equation for estimating a maximum oxygen intake.

From the various information transmitted from the information processing device 3, that is, from the zone setting information, the physiological information of the user, the body movement information, the exercise intensity, the exercise time, and the like, the level determination portion 422 performs detection so as to determine to which zone the exercise performed by the user belongs among the zones Z1 to Z5. Furthermore, from the total exercise time in each of the zones Z1 to Z5, the level determination portion 422 determines the level of exercise habit (any of “0” to “10”) shown in FIG. 10.

For example, in a case where the user performed the exercise of the zone Z5 for 1 hour, the exercise of the zone Z4 for 5 hours, the exercise of the zone Z3 for 2 hours, the exercise of the zone Z2 for 1 hour, and the exercise of the zone Z1 for 0.5 hours per week, a level of exercise habit of the user is determined as being “8” based on the exercise time of each zone of the calculation information.

In a case where the analysis portion 366 of the information processing device 3 calculates a running distance and a walking distance based on a moving distance and a moving speed of the user that is based on a trend of the positional information within a predetermined period of time, and the calculated results are transmitted, the level determination portion 422 may determine a level of exercise habit based on the running distance and the walking distance.

Based on the level of exercise habit of the user determined by the level determination portion 422 and the user information transmitted from the information processing device 3, the estimated value calculation portion 423 estimates a maximum oxygen intake of the user. The user information is information showing the attributes of the user such as the age, gender, and BMI of the user. By plugging the level of exercise habit (for example “8”), age, gender, and BMI of the user into a Jackson's equation, the estimated value calculation portion 423 calculates an estimated value of a maximum oxygen intake.

In the present embodiment, the estimated value calculation portion 423 stores the calculated estimated value of the maximum oxygen intake into the storage portion 41, and takes a moving average including the estimated value of the past as an estimated value of the week. In this way, a short-term variation component of the maximum oxygen intake can be removed.

Based on the estimated value of the maximum oxygen intake, the index calculation portion 424 calculates a physical fitness index showing the physical fitness of the user. The physical fitness index calculated by the index calculation portion 424 is stored in the storage portion 41 by being associated with the time information.

In the present embodiment, the physical fitness index table for determining a physical fitness index based on the gender and age of the user and the estimated value of the maximum oxygen intake is stored in the storage portion 41. The index calculation portion 424 calculates the physical fitness index of the user with reference to the physical fitness index table. The information of the calculated physical fitness index is stored in the storage portion 41 by being associated with the time information (time information) showing the time when the physical fitness index is calculated or the physiological information and the activity information are detected.

As the physical fitness index table, for example, a table described in “Guidelines for Exercise Prescription, Exercise Tolerance Test, and Exercise programs, 8th edition of original book”, pp 84-89, (editor: American College of Sports Medicine) can be adopted, but the invention is not limited thereto. For example, a physical fitness index may be determined based on a pulse rate, an acceleration, an inspired gas, and the like in addition to a maximum oxygen intake.

In the physical fitness index table, as a presentation method for physical fitness indices, the physical fitness indices are classified into 6 evaluation levels consisting of “extremely excellent”, “excellent”, “good”, “normal”, “poor”, and “extremely poor” according to a proportion of an estimated value of a maximum oxygen intake in a frequency distribution, but the invention is not limited thereto. In the present embodiment, 4 levels consisting of “Superior”, “Excellent”, “Good”, and “Fair” are adopted.

The index prediction portion 425 reads out the physical fitness index stored in the storage portion 41 and predicts a change of the physical fitness index. Furthermore, the index prediction portion 425 can calculate an activity amount necessary for an estimated value of a target maximum oxygen intake.

The control portion 42 causes the index calculation portion 424 to calculate various information necessary for the analysis screen FS, for example, physical fitness indices or causes the index prediction portion 425 to predict predictive information, and transmits the information to the information processing device 3 from the communication portion 43. Based on the transmitted information, the information processing device 3 generates and displays the analysis screen FS.

The information about the level according to the current physical fitness index such as “Superior” or “Excellent” may be transmitted to the physiological information detection device 2 from the information processing device 3, and may be displayed on the display portion 241 of the physiological information detection device 2. At this time, characters or objects according to the level may be displayed by being converted into textual information.

Hitherto, each of the constitutions and functions of the physiological information analysis system 1 has been described, but the constitution of each of the functional portions is not limited. For example, an aspect can be considered in which at least one of the level determination portion 422, the estimated value calculation portion 423, the index calculation portion 424, and the index prediction portion 425 included in the control portion 42 of the server device 4 are included in the control portion 36 of the information processing device 3. Furthermore, the zone setting information or the calculation information table may be stored in the storage portion 35.

Furthermore, a so-called stand-alone constitution can also be considered in which the analysis portion 366, the level determination portion 422, the estimated value calculation portion 423, the index calculation portion 424, the index prediction portion 425, the zone setting information, or the calculation information table is included in the control portion 27 of the physiological information detection device 2, such that the physiological information analysis system 1 is realized using only the physiological information detection device 2. In this case, the physiological information detection device 2 corresponds to a physical fitness index display device.

### Physical Fitness Index Information

Next, the analysis screen FS displayed on the display portion 33 of the information processing device 3 will be specifically described.

FIG. 11 shows a physical fitness index trend screen FS1 which is an analysis screen FS corresponding to one of the physical fitness trend information. The physical fitness index trend screen FS1 is generated such that the abscissa as one axis thereof is adopted as a time axis, the ordinate as the other axis thereof is adopted to show estimated values of maximum oxygen intakes, and the estimated values of the maximum oxygen intakes are displayed in a time-series manner.

Each of the estimated values represents a moving average including an estimated value of a maximum oxygen intake of the week. That is, the estimated value calculation portion 423 calculates an estimated value 427 of this week based on the Jackson's equation, and calculates a moving average 426 of this week by reading out estimated values of the past 12 weeks stored in the storage portion 41. The calculated moving average 426 of this week is displayed on the physical fitness index trend screen FS1. In the same manner as described above, a moving average of each week is displayed on the physical fitness index trend screen FS1, and hence the user can visually recognize a time-series change of the maximum oxygen intake.

The “time-series” mentioned herein means history information of physical fitness indices calculated in the past. The “time-series” may include not only the history information of the past physical fitness indices but also the current physical fitness indices or the predicted future physical fitness indices.

The index calculation portion 424 calculates physical fitness indices based on the moving average of the maximum oxygen intake, and the information of the calculated physical fitness indices is drawn in the physical fitness index trend screen FS1. Accordingly, from the physical fitness index trend screen FS1, the user can visually recognize a fact that the physical fitness index is improved with the passage of time or, for example, a fact that the moving average 426 of this week is included in the region of the evaluation section corresponding to “Good”. The level (“Good” in FIG. 11) corresponding to the moving average 426 of this week may be displayed using a color or size different from that of other levels although the mode of display is not shown in the drawing, and this makes it easier for the user to visually recognize the level of the physical fitness index.

The index prediction portion 425 expects that the estimated value 427 of this week will become an expected estimated value 428 after 3 months (12 weeks). That is, the index prediction portion 425 shows that, in a case where the user maintains the current activity amount for 12 weeks, the estimated value will be the estimated value 427 of this week after 12 weeks. Therefore, from the physical fitness index trend screen FS1, the user can visually recognize an estimated value (predictive physical fitness index) or an estimated level (predictive evaluation level) that will be obtained after 12 weeks (3 months).

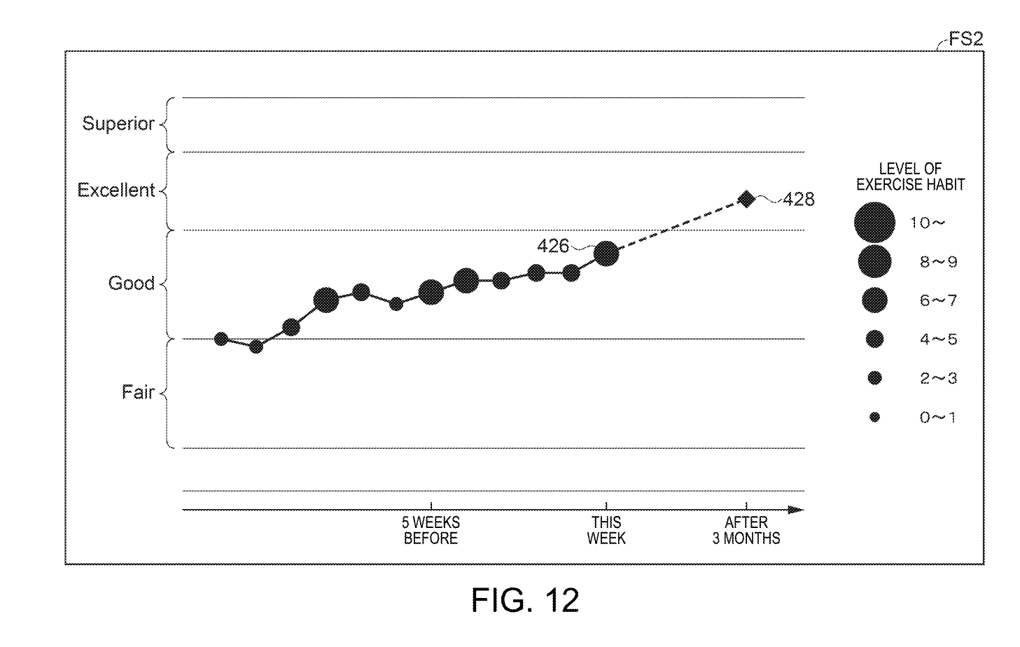

FIG. 12 shows a physical fitness index trend screen FS2 that is considered as being another analysis screen FS. In the physical fitness index trend screen FS2, the size of a mark showing a moving average of each week indicates a parameter used for estimating a maximum oxygen intake, for example, a level of exercise habit (activity amount) of the week. In the present embodiment, the mark is shown as a circle. However, the invention is not limited thereto, and the mark may take other shapes such as a square shape.

An aspect can also be considered in which the color of the mark is changed according to the level of exercise habit, or facial expression of a character such as an object or a person's face is changed. In this way, from the physical fitness index trend screen FS2, the user can visually recognize a time-series change of the level of exercise habit in addition to a time-series change of the maximum oxygen intake.

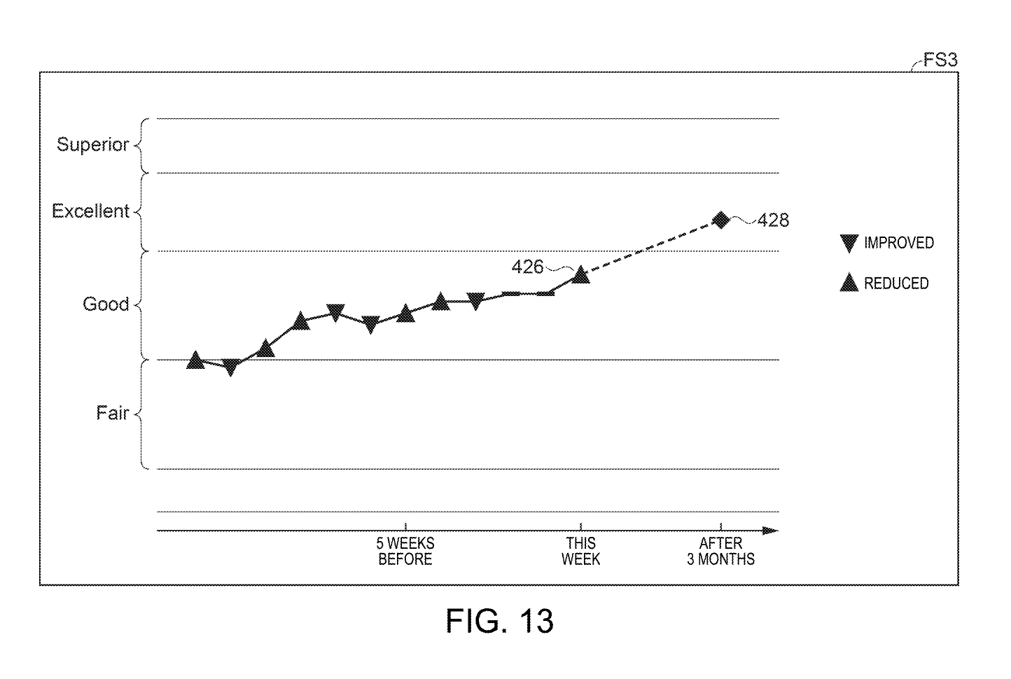

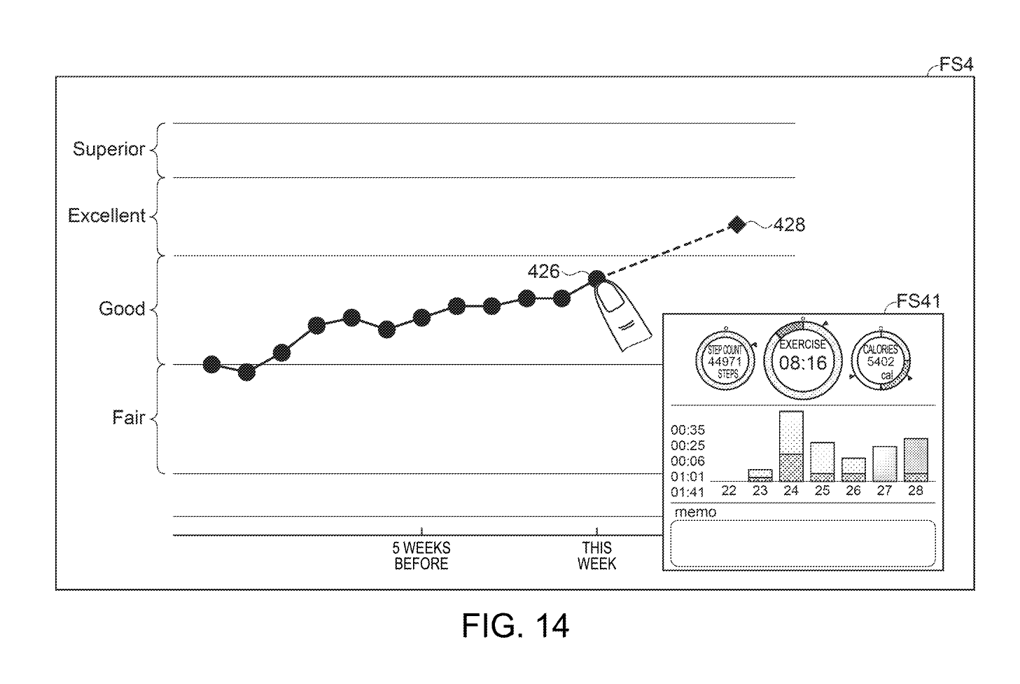

FIG. 13 shows a physical fitness index trend screen FS3 considered as another analysis screen FS. In the physical fitness index trend screen FS3, a direction indicated by a triangle showing a moving average of each week shows a result of comparison between a level of exercise habit of this week and a level of exercise habit of the last week. That is, in a case where the level of exercise habit of this week is improved compared to the level of exercise habit of the last week, the triangle points upwards, and in a case where the level of exercise habit of the week is reduced compared to the level of exercise habit of the last week, the triangle points downwards.

In this way, from the physical fitness index trend screen FS3, the user can visually recognize a time-series change of a trend of a level of exercise habit in addition to a time-series change of a maximum oxygen intake. In the present embodiment, the mark is shown as a triangle. However, the invention is not limited thereto, and the mark may take other shapes such as an arrow shape. Furthermore, the size or color of the triangle may be changed according to the level of exercise habit.

FIG. 14 shows a physical fitness index trend screen FS4 considered as another analysis screen FS. The physical fitness index trend screen FS4 is formed such that a mark showing a moving average of each week can be selected. In a case where the user selects a desired mark by using a finger or a mouse, a subsidiary screen FS41 overlapped with the physical fitness index trend screen FS4 is loaded and displayed. On the subsidiary screen FS41, an activity amount corresponding to the time indicated by the selected mark, for example, exercise information, step count information, and calorie information are displayed.

The information displayed on the subsidiary screen FS41 is not limited to the above. For example, the subsidiary screen FS41 may display a graph in which the physical fitness of the user is compared with the physical fitness of other people (for example, user's friends, celebrities, and sportsmen), a graph showing a trend of a minimum pulse rate for ascertaining the body condition, and the like.

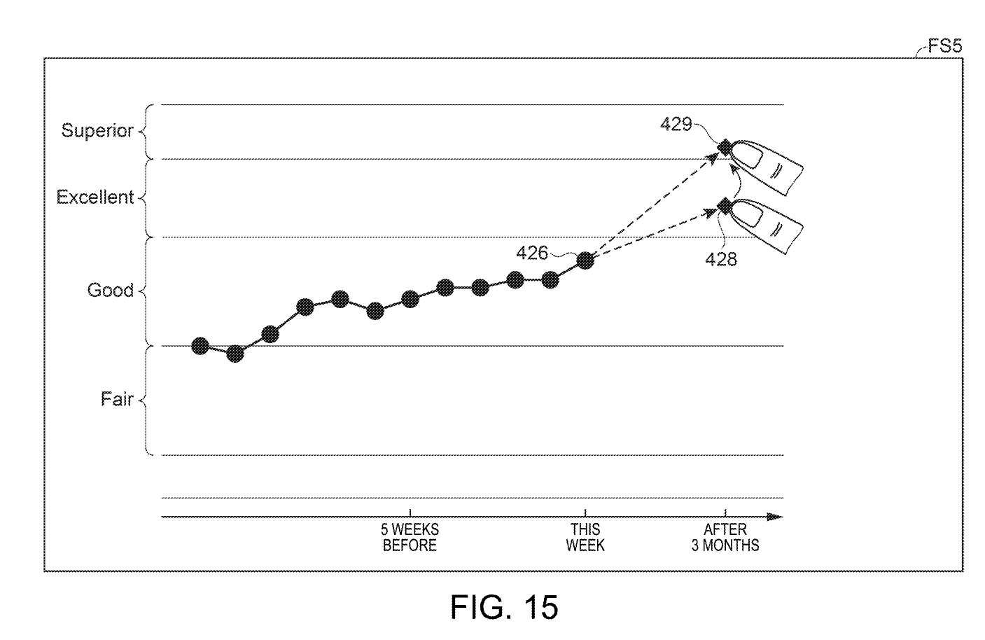

FIG. 15 shows a physical fitness index trend screen FS5 considered as another analysis screen FS. On the physical fitness index trend screen FS5, a mark showing an expected estimated value 428 is displayed in a selectable state. In a state where the user selects the mark of the expected estimated value 428 by using a finger or the like and moves the mark, that is, in a case where the mark is moved in the selected state along the direction of the ordinate and then deselected in a desired position, the position in which the mark is deselected is determined as being a second expected estimated value 429.

In other words, the operation performed as above corresponds to an operation of changing a relative position between the moving average 426 of this week, which is the current physical fitness index, and the expected estimated value 428. Alternatively, the operation performed as above corresponds to a process in which the operation portion 31 accepts an operation which is for changing a relative position between the physical fitness index trend screen FS5 as a graph showing a trend of the current physical fitness index from the past and a display position of predictive information.

In a case where the control portion determines that the relative position has been changed based on a signal from the operation portion, the informing portion displays necessary activity information necessary for reaching the physical fitness index corresponding to the predictive information of which the relative position has been changed. As a result of executing processing of moving the predictive information (expected estimated value 428) based on the signal from the operation portion 31 as described above, the target estimated value becomes a second expected estimated value 429, and the target physical fitness index reaches the level (in this case, “Superior”) represented by the second expected estimated value 429.

The index prediction portion 425 calculates an activity amount (target activity information) necessary for shifting to the second expected estimated value 429 of the maximum oxygen intake. That is, the index prediction portion 425 calculates a level of exercise habit through inverse operation of the Jackson's equation and obtains an activity amount according to the calculated level of exercise habit, for example, a period of time for which an aerobic exercise should be performed, a period of time necessary in a case where jogging is performed, and a period of time necessary in a case where cycling is performed, with reference to the calculation information table shown in FIG. 10. The obtained information is displayed on the display portion 33. Alternatively, necessary activity amount information (necessary activity information such as exercise intensity, exercise time, type of exercise, and frequency of exercise) may be displayed together with the physical fitness index trend screen FS5. Accordingly, the user can visually recognize the information of the activity amount for reaching the target maximum oxygen intake or physical fitness index.

The moving direction of the selected mark is not limited to a longitudinal direction, and an aspect can also be considered in which the mark is moved in a horizontal direction, that is, the time taken for the mark to reach the second expected estimated value 429 is changed. Furthermore, the mark may be moved in an oblique direction.

The object showing predictive information (expected estimated value 428) and the object showing the current physical fitness index from the past may be displayed in different aspects by changing the color, size, shape, and the like.

The invention is not limited to the aspect in which a time-series change of the maximum oxygen intake is displayed. For example, an aspect can also be considered in which the level of exercise habit is displayed using a cumulative time by using a bar graph, a radar chart, or a pie graph.

The analysis screen FS displayed on the display portion 33 may be switched by the selection of the aforementioned physical fitness index trend screens (FS1 to FS5) through the operation performed by the user or may be automatically switched at a predetermined time interval.

With the physiological information analysis system 1 according to the present embodiment, a level of exercise habit of a user can be determined based on physiological information and body movement information of the user; an estimated value of a maximum oxygen intake is calculated using a Jackson's equation based on the determined level of exercise habit and user information; and a physical fitness index showing the physical fitness of the user is calculated based on the calculated estimated value of a maximum oxygen intake. Furthermore, the calculated physical fitness index is sored, and a time-series trend of the physical fitness index is displayed. Therefore, the historical trend of the physical fitness can be easily visually recognized, and the current way of exercise and the appropriateness of lifestyle can be verified.

In addition, a future physical fitness index can be predicted, and the content of training necessary for achieving a target physical fitness index can be visually recognized.

The system performing the methods descried so far includes various aspects.

For example, an aspect can also be considered in which each of a plurality of users wears the physiological information detection device 2 and holds the information processing device 3. In this case, the server device 4 may be connected to a plurality of information processing devices 3, and the control portion 42 may cause trends of physical fitness indices of the respective users to be displayed together in a single physical fitness index trend screen.

Furthermore, an aspect can also be considered in which a single information processing device 3 is connected to a plurality of physiological information detection devices 2.

Each of the functional portions such as the control portion 27 shown in FIG. 3, the control portion 36 shown in FIG. 5, and the control portion 42 shown in FIG. 8 shows a functional constitution realized by a cooperation between hardware and software, and the specific mounting form thereof is not particularly limited. Therefore, hardware separately corresponding to each of the functional portions is not necessarily mounted on the device, and it goes without saying that a constitution can be adopted in which a single processor realizes functions of a plurality of functional portions by executing programs. Furthermore, in the aforementioned embodiment, some of the functions realized by software may be realized by hardware, or, some of the functions realized by hardware may be realized by software.

What is claimed is:

1. A physical fitness index display system, comprising:
a physiological information detection portion that detects physiological information about a user;
an activity information detection portion that detects activity information showing activities of the user;
a calculation portion that calculates physical fitness indices showing the physical fitness of the user based on the physiological information and the activity information;
a display portion that displays information about the physical fitness indices; and
a control portion that causes the display portion to display history information obtained by relating a plurality of physical fitness indices to time information.

2. The physical fitness index display system according to claim 1,
wherein the control portion classifies the physical fitness indices into a plurality of evaluation levels and causes the display portion to display information about the evaluation levels according to the physical fitness indices.

3. The physical fitness index display system according to claim 1,
wherein the control portion predicts a trend or change of the physical fitness indices and causes the display portion to display predictive physical fitness index information predicted.

4. The physical fitness index display system according to claim 1,
wherein the calculation portion obtains user information about attributes of the user, estimates maximum oxygen intakes of the user based on the physiological information, the activity information, and the user information, and determines the physical fitness indices based on the user information and the maximum oxygen intakes.

5. The physical fitness index display system according to claim 4,
wherein the control portion determines the physical fitness indices by using a moving average of the plurality of maximum oxygen intakes obtained for a predetermined period of time.

6. The physical fitness index display system according to claim 2,
wherein the history information is a graph in which one axis is used as a time axis and the other axis shows values of the physical fitness indices or the evaluation levels of the physical fitness indices by using the plurality of pieces of physical fitness index information and the time information.

7. The physical fitness index display system according to claim 3,
wherein the history information is a graph in which one axis is used as a time axis and the other axis shows the predictive physical fitness index information and at least either the values of the physical fitness indices or the evaluation levels of the physical fitness indices by using the plurality of pieces of physical fitness index information and the time information.

8. The physical fitness index display system according to claim 7, further comprising:
an operation portion that is connected to the control portion through electronic communication,
wherein in a case where the operation portion accepts an operation of changing the predictive physical fitness index information, the control portion calculates target activity information necessary for reaching the changed predictive physical fitness index information and causes the display portion to display the calculated target activity information.

9. The physical fitness index display system according to claim 4,
wherein the control portion associates the physical fitness index information with at least one of the physiological information, the activity information, the user information, and the maximum oxygen intakes used for determining the physical fitness index information.

10. The physical fitness index display system according to claim 9,
wherein in a case where one of the plurality of pieces of physical fitness index information is selected, a physical fitness index trend information displays at least one of the physiological information, the activity information, the user information, and the maximum oxygen intakes relating to the selected physical fitness index information.

11. A physical fitness index display device comprising:
a physiological information obtainment portion that obtains physiological information about a user;
an activity information obtainment portion that obtains activity information showing activities of the user;
a timepiece portion that outputs time information;
a calculation portion that calculates physical fitness indices showing the physical fitness of the user based on the physiological information and the activity information; and
an output portion that outputs the physical fitness indices by relating the physical fitness indices to the time information.

12. The physical fitness index output device according to claim 11,
wherein the calculation portion classifies the physical fitness indices into a plurality of evaluation levels and generates information about the evaluation levels according to the physical fitness indices.

13. The physical fitness index output device according to claim 11,
wherein the calculation portion generates predictive information that predicts a trend or change of the physical fitness indices, and
the output portion outputs the predictive physical fitness index information.

14. The physical fitness index output device according to claim 11,
wherein the output portion is a communication portion and communicates the physical fitness indices and the time information to an external instrument.

15. The physical fitness index output device according to claim 14,
wherein the communication portion obtains information about the evaluation levels corresponding to the physical fitness indices communicated to the external instrument.

16. The physical fitness index output device according to claim 14,
wherein the communication portion obtains predictive physical fitness index information that is generated based on the communicated physical fitness indices and predicts a trend or change of the physical fitness indices.

17. The physical fitness index output device according to claim 11,
wherein the output portion is an informing portion and informs the user of the physical fitness indices and the time information.

18. The physical fitness index output device according to claim 12,
wherein the output portion is an informing portion and informs the user of the physical fitness indices and the time information.

19. The physical fitness index output device according to claim 13,
wherein the output portion is an informing portion and informs the user of the physical fitness indices and the time information.

20. The physical fitness index output device according to claim 17,
wherein the informing portion is a display portion, and
the display portion displays a graph in which one axis is used as a time axis and the other axis shows at least one physical fitness index or the evaluation levels of the physical fitness indices.

21. The physical fitness index output device according to claim 20,
wherein the informing portion displays the graph showing the evaluation levels of the physical fitness indices and the predictive physical fitness index information.

22. The physical fitness index output device according to claim 21, further comprising:
an operation portion that accepts an operation of changing a relative position between a display position of the graph and a display position of the predictive physical fitness index information,
wherein in a case where the relative position has been changed, the informing portion displays necessary activity information necessary for reaching a physical fitness index corresponding to the predictive information of which the relative position has been changed.

23. The physical fitness index output device according to claim 20, further comprising:
an operation portion that accepts an operation for selecting the physical fitness indices displayed as the graph on the informing portion, and the informing portion displays a subsidiary screen for displaying information about the selected physical fitness indices based on a signal from the operation portion.

24. The physical fitness index output device according to claim 17,
wherein the informing portion displays the evaluation levels of the physical fitness indices and the predictive physical fitness index information in different aspects.

25. A physical fitness index output device comprising:
a calculation portion that calculates physical fitness indices showing the physical fitness of a user based on information from a sensor mounted on the body of the user; and
an output portion that outputs the physical fitness indices and time information showing the time when the information is obtained from the sensor by relating the physical fitness indices to the time information.

26. The physical fitness index output device according to claim 25,
wherein the calculation portion classifies the physical fitness indices into a plurality of evaluation levels and generates evaluation level information about the evaluation levels according to the physical fitness indices, and
the output portion outputs the evaluation level information.

27. The physical fitness index output device according to claim 25,
wherein the sensor includes a physiological information detection portion that detects physiological information about the user and a body movement information detection portion that detects body movements of the user.

28. The physical fitness index output device according to claim 25,
wherein the physical fitness indices include at least one of a cardiopulmonary function, a maximum oxygen intake, a threshold of anaerobic work, physical fitness age, and a maximum heart rate.

29. The physical fitness index output device according to claim 25,
wherein the output portion is an informing portion and informs the user of the physical fitness indices and the time information.

30. The physical fitness index output device according to claim 29,
wherein the informing portion is a display portion, and
the display portion displays a graph, which shows a time-series change of the physical fitness indices or the evaluation levels of the physical fitness indices, based on the physical fitness indices and the time information.

31. The physical fitness index output device according to claim 30,
wherein the display portion displays predictive physical fitness indices predicted based on the physical fitness indices and the time information or predictive evaluation levels deduced based on the predictive physical fitness indices.

32. A physical fitness index display method comprising:
obtaining physiological information of a user, activity information showing activities of the user, and time information showing the time when the physiological information or the activity information is obtained;
calculating physical fitness indices showing the physical fitness of the user based on the physiological information and the activity information; and
displaying the physical fitness indices in a time-series manner based on the time information.
